(19) United States
(12) Patent Application Publication
(10) Pub. No.: US 2025/0257803 A1
(43) Pub. Date: Aug. 14, 2025

(54) CONNECTION ADAPTER

(71) Applicant: Cold Solutions VBB Kältetechnik GmbH, Mühlhausen (DE)

(72) Inventor: Peter Behrends, Mühlhausen (DE)

(21) Appl. No.: 19/053,516

(22) Filed: Feb. 14, 2025

(30) Foreign Application Priority Data
Feb. 14, 2024 (DE) 102024104162.5

(51) Int. Cl. F16K 1/30; F16L 37/23; F16L 37/46

(52) U.S. Cl. CPC F16K 1/308; F16L 37/23; F16L 37/46

(57) ABSTRACT

Connection adapter for docking and undocking a maintenance station to a service valve of a third-party system in which a working fluid circulates in a closed circuit with a connection via which for filling working fluid under pressure can be fed from the maintenance station into the connection adapter or via which working fluid under pressure can be discharged, with a dead space which is ventilated via a venting path, the connection adapter includes a servo space in which a servo piston for opening and closing the venting path is accommodated, and a valve spindle that operates a valve element, and a hold-down device for opening a spring valve insert forming the service valve, which is designed and arranged in such a way that it only opens the spring valve insert after the servo piston has reached a position closing the ventilation path.

### FIELD OF THE INVENTION

The invention relates to a connection adapter for docking and undocking a maintenance station to a service valve.

### BACKGROUND

So-called connection adapters are often used to safely create a detachable flow path between two fluid systems, with one system usually being equipped with these connection adapters.

For example, evacuation, filling- and service- and maintenance stations for MV air conditioning systems (MV=motor vehicle) are equipped with such connection adapters in order to be able to safely carry out filling with coolants, discharging the coolants, evacuation or even service activities on MV air conditioning systems.

In modern MV air conditioning systems, more environmentally friendly CO₂ is currently often used as a coolant. The CO₂ as a coolant for MV air conditioning systems is an environmentally friendly alternative to the previously often used coolant tetrafluoroethane (also: R134a). CO₂ is significantly more environmentally friendly, has a high cooling output, is non-flammable, does not form decomposition products and is available worldwide at low cost. In cooling technology, the natural coolant carbon dioxide (CO₂) is referred to with the abbreviation R774. However, in order to have the CO₂ available in the required liquid state, it must be exposed to a significantly higher pressure—compared to tetrafluoroethane—which can lead to dangerous conditions for operating personnel when filling or releasing the CO₂ as a coolant.

In general, due to the environmental damage caused by the release of coolants and/or the danger to operating personnel, the automotive industry and the MV crafts high demands on the properties of connection fittings such as the connection adapters mentioned.

The use of environmentally friendly CO₂ as a coolant has made these requirements even more severe due to the very high pressure mentioned. Accordingly, such connection fittings should/must, for example:
have a pressure relief function;
have a self-alignment function of the valve pusher;
have a separate and unique function for opening and closing a service valve;
do not allow to be detached from the service valve when the flow path is open;
have a locking mechanism for secure connection to a service valve;
be clearly marked for assignment to the high pressure or low pressure of a fluid system to be connected;
ensure secure locking onto a valve body before hydraulic opening;
have a pulling force when locked of more than 5000 N;
require a maximum pulling force of less than 50 N after hydraulic closing;
if the service valve is not connected, reliably ensure that no fluid (coolant) can escape;
prevent mechanical uncoupling from the service valve from being possible when the flow path is open;
be designed for at least 5000 mating cycles;
have ventilation of the dead space between the connection adapter and the service valve in order to reduce the pressure after the flow path has been interrupted and before uncoupling and to be able to detect a valve insert in the service valve that is not closing properly;
ensure the pressure reduction via the connection fittings or via the service device and
have a defined pin low pressure position;
maintain a precisely defined place and path until the “seal is broken” and the service valve is completely opened.

These requirements sometimes require very contradictory functions, so that no previous known solution can implement them in their entirety.

The majority of previous solutions also do not have a long-term durability of the sealing systems and at the same time a high degree of tightness during operation. This is particularly true at high system pressures, which must be dealt with in the case of CO₂. In particular, the diametrically opposed requirement of opening and closing a flow path and venting the dead space as well as the requirement that no coolant may escape when the service valve is decoupled mean that most solutions do not have a pressure relief function or venting of the dead space.

At best, such connection fittings can only be used at service stations that have their own pressure relief function. Solutions that represent both functions force compromises in the dimensioning of the necessary sealing elements due to the path available for opening/closing the flow path or ventilation, which limits durability. Further solutions that meet both of the above requirements require a second energy source.

### OBJECT OF THE INVENTION

Against this background, the object of the invention is to specify a connection fitting with which a temporary, high-pressure flow path between two fluid systems can be produced safely and preferably without tools.

### Solution According to the Invention

According to the invention, a connection adapter is proposed for docking and undocking a maintenance station to a service valve of a third-party system, in which a working fluid circulates in an—at least essentially—closed circuit, in particular an air conditioning system—ideally in the form of a vehicle air conditioning system. The maintenance station in question can also be, for example, an evacuation station, filling station, measuring station and/or service station. For the sake of simplicity, such a station will be referred to below as a “maintenance station”. In the third-party system mentioned—particularly preferably in the form of a vehicle air conditioning system—a working fluid circulates in an at least essentially closed circuit, which always includes a time-dependent leak that exists in real systems. In addition, such a third-party system also includes a system in which the working fluid does not yet circulate in a closed circuit, but should circulate immediately, which is the case, for example, with an initial filling of the third-party system with a working fluid.

The connection adapter according to the invention includes a connection via which—during the filling process—working fluid under pressure can be fed from the maintenance station into the connection adapter, fluid under pressure can be discharged into the maintenance station or a negative pressure can be generated during the evacuation process.

In addition, the connection adapter according to the invention comprises a dead space—preferably between the connection adapter and the service valve—which is also ventilated via a ventilation path when the service valve is coupled to the connection adapter; at least as long as his own setback valve is still closed. Timely ventilation of the dead space increases safety when uncoupling. In addition, you will notice early on and before anything can happen if the spring valve insert has not closed unexpectedly.

The connection adapter according to the invention also includes a servo space that can be fluidically connected to the connection—and can also be separated from it. A servo piston for opening and closing the ventilation path is accommodated in this servo space. If there is excess pressure in the servo space, this servo piston is pushed towards its position that closes the ventilation path.

The connection adapter according to the invention also includes a valve spindle which operates a first valve element and a second valve element. Here, the valve spindle itself preferably forms the valve elements; ideally even integrally in one piece.

Here, the first valve element is designed and positioned in such a way that when the valve spindle moves to initiate the opening of the service valve or by another component to open the service valve, it connects the servo space fluidically to the connection. The “opening” of the service valve is preferably synonymous with the opening of the spring valve insert of the service valve.

The second valve element is designed and positioned in such a way that it only opens and connects the dead space fluidically with the servo space—and thus also with the connection—after the servo piston has reached a position that closes the ventilation path.

In addition, the connection adapter according to the invention includes a hold-down device for opening the spring valve insert, which forms part of the service valve. This hold-down device is designed and arranged so that it only opens the spring valve insert after the servo piston has reached a position closing the vent path.

The special arrangement of the components of the connection adapter relative to one another enables safe filling and also evacuation of the external system when using only one connection adapter. This means the maintenance station can easily be connected to the third-party system. The ventilation path allows pressure to escape safely if necessary. The servo piston acts as a closure for the ventilation path and closes it automatically when there is a corresponding pressure in the servo compartment. A first step can then be taken with the first valve element to connect the servo space with the dead space in order to create the flow path.

The second valve element can only open and finally fluidically connect the dead space with the servo space after the servo piston has reached a position closing the ventilation path.

Thus, with this one connection adapter, a safe way can be created to connect a third-party system with a wide variety of evacuation, filling, maintenance and service stations, and this can happen regardless of the type of pressure reduction. In addition, the requirements of the automotive industry and the MV craft can also be met.

### FURTHER POSSIBLE EMBODIMENTS OF THE INVENTION

A preferred embodiment of the connection adapter is when the servo piston has at least one upper pressure-loaded end face and at least one lower pressure-loaded end face, the ratio of which is selected such that the servo piston is pressed against the force of a servo piston spring in a sealing manner against the second valve element and/or—preferably; and—against the stop of a sliding sleeve. In addition, it is preferred that—if there is a pressure in the servo chamber that is smaller than the limit pressure, the servo piston is pressed by the force of a servo piston spring to the upper stop on the valve housing.

The limit pressure mentioned can preferably be chosen variably and is preferably in a range from 0.5 MPa to 10 MPa, particularly preferably in a range from 0.5 MPa to 5 MPa, here preferably 1 MPa.

This ensures that, on the one hand, the connection adapter is securely fixed to a coupled service valve with an internal system pressure that is larger than the limit pressure. On the other hand, for a system pressure that is lower than the limit pressure it is ensured that the servo piston safely clears the vent path.

In addition, it is particularly preferred if the valve spindle used to control the valves that connect the connection to the dead space has a first valve element—preferably designed as a cylindrical ring-shaped valve plate—and a second valve element—preferably designed as a cone-section-shaped—preferably as a full-cone-section-shaped—valve plate—which cooperates with a valve seat on the servo piston in such a way that the servo piston is separated from the second valve element when the valve element is coupled to the fluid connection adapter can be held against a pressure in the servo space in a position that does not close the vent path and can be pulled from its position that closes the vent path into a position that does not close the vent path when the connection adapter is uncoupled from the fluid. This ensures that the ventilation path—whether when coupling or uncoupling—can always be opened to enable ventilation. This further contributes to workplace safety.

In addition, it is particularly preferred if the valve spindle forms the hold-down device at one end for opening the spring valve insert which forms part of the service valve, which preferably merges into the rest of the valve spindle via a collar for self-alignment of the hold-down device. Here, the hold-down device preferably has a first radial bore, which merges into a second radial bore intersected with it in the valve spindle via an axial bore intersected with it and thus creates a fluid connection between the space below a collar of the valve spindle and the space within the servo piston and within the sliding sleeve when the service valve is coupled. As an alternative to arranging these bores, the collar mentioned can also be formed with flow paths on the cylinder surface that run parallel to the valve axis. Both versions provide a simple and secure fluid connection between the two rooms.

In addition, it is particularly preferred if the first valve element is designed and positioned in such a way that if there is no excess pressure in the servo space—as can occur when docking and undocking for the purpose of emptying if the connection does not carry any excess pressure—it can press the servo piston into a position that closes the ventilation path by positive locking. So even during the evacuation process, in which the servo piston is not pressed into a position that closes the ventilation path by the excess pressure, it can be brought into the corresponding position in another way. For this purpose, a positive connection is preferably produced between the first valve element and the servo piston. This represents a simple and safe mechanical option for closing the ventilation path in this case.

A particularly preferred embodiment is that the valve spindle is guided in an axially displaceable manner in a preferably multi-part valve housing, which as a rule also delimits the servo space and the dead space—and for this purpose is preferably at least partially limited to the outside—and ideally also carries or can accommodate the connection. Here, the valve housing carries a valve actuator connected to it via a thread, with the help of which the valve spindle—which is preferably connected to the valve actuator via roller bearings—can be moved back and forth in the axial direction relative to the valve housing. The thread is preferably an adjusting thread with a reduced pitch compared to the standard metric thread or a fine thread. This creates a simple way to manually move the valve spindle axially and to be able to adjust the associated valve positions.

In addition, it is particularly preferred if the valve housing carries a locking sleeve that is axially displaceable relative to it, which on the one hand—preferably at its one axial end inclined towards the valve actuator—interacts in a form-fitting manner with the valve actuator and on the other hand—preferably at its other axial end which is inclined towards the valve actuator—interacts in a form-fitting manner with locking balls for locking a service valve in its connected position. They preferably interact in such a way that, as long as no service valve is connected to the connection adapter, the locking sleeve is supported against the locking balls in such a way that it cannot be moved further beyond the locking balls in the axial direction and thereby forms a stop for the valve actuator, which prevents its further axial displacement in the direction of the valve housing. This means that the connection adapter cannot be opened improperly if, for example, the worker is not aware that a very high pressure is “lurking” here.

Alternatively or additionally, they preferably interact with one another in such a way that, as long as a service valve is connected and the first valve element is not yet closed, the valve actuator prevents the locking sleeve from being moved into its unlocking position, in which it allows the locking balls to be displaced in a radially outward direction. This means that it is impossible for a worker to release the connection adapter from its lock with the service valve when the system is under pressure by moving the locking sleeve accordingly, which then flies away explosively when the internal pressure is high. When the service valve is not pushed in, the locking balls are preferably located in conical bores that are so narrow radially inwards that the balls can never fall out inwards—in the direction of the valve axis.

It is also particularly preferred if a sliding sleeve is supported on the servo piston via a spring element, preferably in the form of a servo piston spring, which has an apron on the outer end—preferably at its axial end, which is on the side facing the service valve—which forms a ball counter bearing which, as long as no service valve is coupled to the connection adapter, blocks the locking balls between it and the locking sleeve in such a way that the locking balls hold captured the locking sleeve between itself and the valve actuator, and the sliding sleeve is moved by pushing in the service valve so far in the direction of the servo piston that the apron releases the locking balls for insertion into the corresponding locking groove of the service valve. In this way, a simple and safe mechanical mechanism is created in order to be able to determine whether the service valve is securely coupled and to only allow various processes when the service valve is coupled.

In addition, it is particularly preferred if the locking sleeve is biased relative to the valve housing, preferably relative to the valve housing lower part, by a spring, the design being such that the locking sleeve uses said spring—since the locking sleeve is pressed downwards by the spring in the direction of the service valve—to press the locking balls in a radially inward direction into the locking groove of the service valve and hold them there captive as soon as the sliding sleeve has moved so far in the direction of the Servo piston has been moved so that its apron releases the locking balls. In this way, the spring additionally secures the service valve from unintentional disconnection in a simple mechanical manner, as it presses the locking sleeve downwards so that it holds the locking balls—preferably via a shoulder—securely in the locking groove of the service valve.

In addition, it is particularly preferred if the sliding sleeve has a preferably hollow cylindrical section into which the servo piston is sealingly immersed in order to close the ventilation path. This provides the servo piston with a simple opportunity to close the ventilation path there.

A further preferred embodiment is that the servo piston and the sliding sleeve are mounted together via a rolling bearing, usually in the form of a linear bearing. This rolling bearing is particularly preferably designed in the form of or in the manner of a ball or recirculating ball sleeve. This facilitates the relative axial movement between the servo piston and the sliding sleeve, even under high pressures. Ideally, this avoids jamming and/or jerky movements between both components both in the upward axial direction (in the direction of the valve actuator) and in the downward axial direction (in the direction of the service valve).

In addition, it is particularly preferred if the sliding sleeve forms a stop for the servo piston, which prevents its further axial displacement in the direction of the service valve. In this way, the freedom of movement of the servo piston can be limited in a simple manner, which means that the blocking of the ventilation path can take place in a defined manner.

In addition, it is particularly preferred if the sliding sleeve transmits the pressure force communicated to it by the servo piston to the locking balls. In this way, the locking balls additionally secure the service valve in a simple mechanical manner against unwanted uncoupling, as this intensifies the locking of the service valve.

A further preferred embodiment is that the valve spindle is designed in such a way that it passes over a locking point, which haptically informs the user when the valve actuator is actuated that from now on he will push open the spring valve insert and/or end the forced opening of the spring valve insert, the locking point preferably being generated by a locking ball pin, the ball of which is temporarily inserted into an annular groove in the valve spindle. In this way, a haptic warning message can be communicated to the user in a simple manner.

In addition, it is particularly preferred if the venting path is formed by at least one transverse bore in the sliding sleeve, at least one transverse bore in the valve housing and ideally a further part of the venting path by at least one transverse bore in the locking sleeve, the transverse bore in the locking sleeve ideally being offset from the rest of the venting path in such a way that an axial throttle gap is formed between the rest of the venting path and the transverse bore in the locking sleeve becomes. This throttling of the pressure via this axial throttle gap is necessary, for example, if the spring valve insert does not close properly again due to an error. Larger quantities of work fluids, which are initially under high excess pressure, must then be blown off via the ventilation path. The axial throttle gap mentioned offers a simple and safe way to reduce this high pressure.

Further possible configurations, functions and advantages result from the dependent claims and/or the following description of the exemplary embodiment and/or with reference to the figures.

### BRIEF DESCRIPTION OF DRAWINGS

FIG. 1 shows the connection adapter in a sectioned front view without the service valve.

FIG. 2 shows the connection adapter in a sectioned front view with the service valve that has not yet been inserted.

FIG. 3 shows the connection adapter in a sectioned front view when docking and locking a service valve.

FIG. 4 shows the connection adapter with the service valve inserted in a sectioned front view at the start of opening.

FIG. 5 shows the connection adapter with the service valve inserted in a sectioned front view when it is completely opened.

FIG. 6 shows the connection adapter with the service valve inserted in a sectioned front view at the start of closing.

FIG. 7 shows the connection adapter with the service valve inserted in a sectioned front view when it is completely closed.

### PREFERRED EMBODIMENT

### The Connection Adapter Construction in General

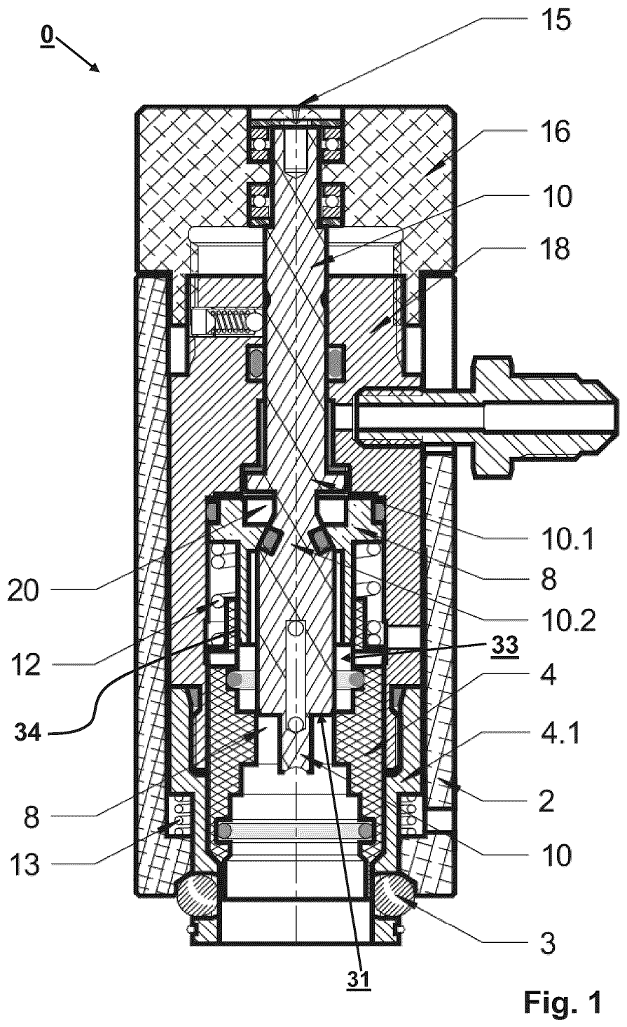

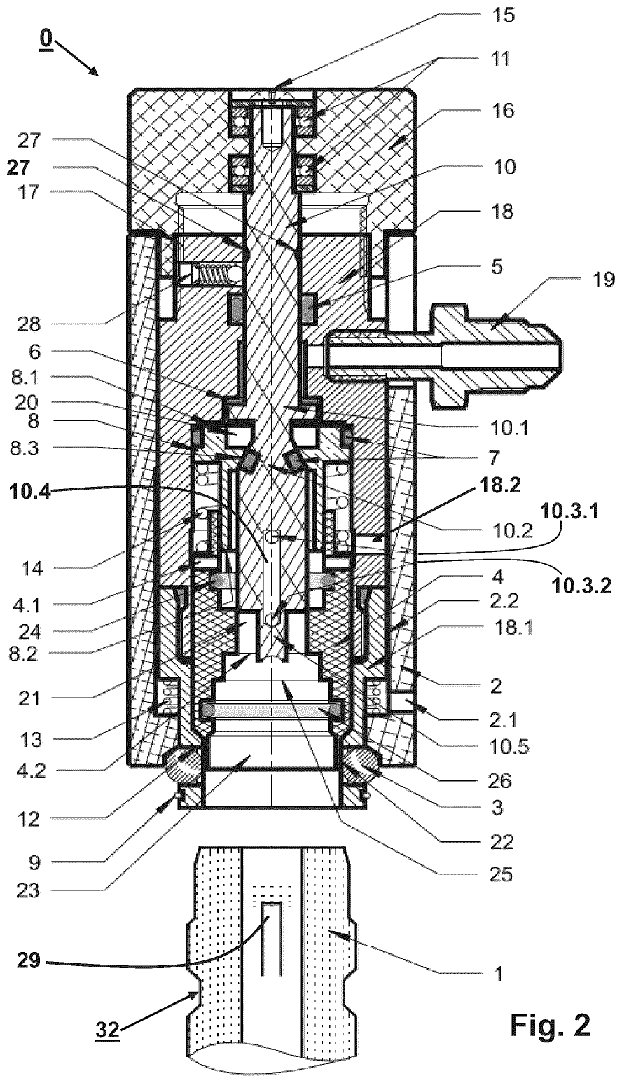

FIG. 1 and FIG. 2 show the general, preferred design of a connection adapter 0, with FIG. 2 also showing the service valve 1 for a better overview, which will later be coupled to the connection adapter 0. The coupling of the service valve 1 and the various switching positions of the connection adapter with the service valve 1 coupled will be explained step by step later. First, however, the general design of the individual parts of the connection adapter 0 and the service valve 1 will be discussed.

The service valve 1 is preferably a valve from a third-party system to which the connection adapter 0 is connected. This service valve 1 preferably comprises a spring valve insert 29. If this spring valve insert 29, which usually forms a type of non-return valve, is pressed downwards—into the service valve 1—the flow path of the service valve 1 is released. In addition, the service valve 1 preferably also comprises a circumferential locking groove 32 on its peripheral surface, into which the locking balls 3 can later engage, which will be explained in more detail later.

The connection adapter 0 itself preferably comprises a valve actuator 16 at one axial end. This valve actuator 16 preferably comprises a thread 17 on its inner peripheral surface—preferably in the form of a fine thread. This thread 17 corresponds to the corresponding thread 17 of the valve housing 18. The thread 17 of the valve housing 18 is preferably attached to a shoulder at the upper axial end (in the direction of the valve actuator 16) of the valve housing 18. This shoulder serves, on the one hand, as a support for the thread 17 and, on the other hand, preferably also as a stop for the valve actuator 16 when fully screwed in. The valve housing 18 is preferably made in several parts—in the preferred exemplary embodiment shown, in two parts. The valve housing lower part 18.1 carries the already mentioned conical bores 12, which carry the locking balls 3 as long as the service valve 1 is not engaged. The upper part of the valve housing 18 preferably carries at least one transverse bore 18.2 in the area in which the servo piston 8 moves, which is part of the ventilation path, which will be examined in more detail later.

It is also preferred that the upper part of the valve housing 18 carries a spring-loaded locking ball pin 28, preferably in a corresponding recess, which can engage in a preferably circumferential, corresponding annular groove of the valve spindle 10. Also preferably in the upper part of the valve housing 18 there is a preferably circumferential groove for receiving a sealing element 5 between the valve housing 18 and the valve spindle 10. In addition, it is further preferred if the valve housing at least partially carries the connection 19 of the connected maintenance station, preferably by offering a corresponding thread.

The valve housing lower part 18.1 also preferably comprises a stop element 9 or a groove in which a stop element 9 is fastened. This stop element 9 is preferably located below (axially along the valve axis 15 in the direction of the service valve 1) of the cone bores 12.

The valve housing lower part 18.1 also preferably comprises a shoulder on which a spring 13, preferably in the form of a pressure spring, can be supported.

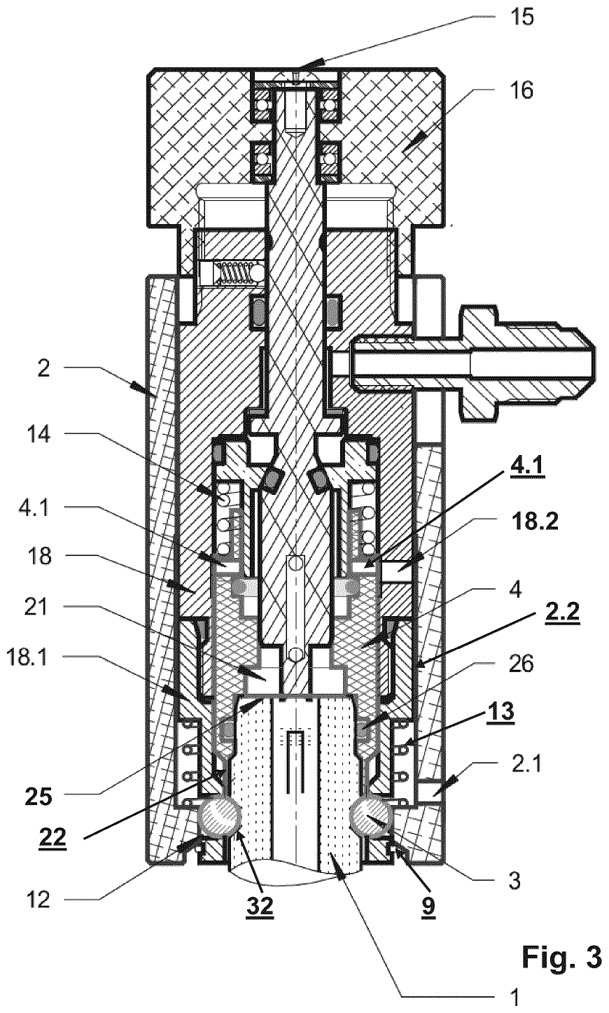

The other side, on which the corresponding spring 13 can be supported, is preferably located on a shoulder of a locking sleeve 2, which preferably at least partially encloses the valve housing 18. This paragraph mentioned preferably merges into a preferably circumferential groove, which additionally partially supports the locking balls 3 in the non-triggered state of the locking sleeve shown. In the triggered state of the locking sleeve 2 (see FIG. 3), the corresponding paragraph interacts with the stop element 9 in such a way that it offers a lower stop for the triggered locking sleeve 2, which is pressed downwards (axially along the valve axis 15 towards the service valve 1) by the spring force of the spring 13. In this triggered state (see FIG. 3), the shoulder also offers further support for the locking balls 3 against radial displacement away from the valve axis 15, since the locking balls 3 have been moved inwards (towards the valve axis 15) in the conical bores 12 in the triggered state of the locking sleeve 2.

FIG. 3 and this “snapping” of the locking sleeve 2 will be explained in more detail in a later section.

Preferably above (axially along the valve axis 15 in the direction of the valve actuator 16) the shoulder of the locking sleeve 2, the locking sleeve 2 comprises at least one transverse bore 2.1, which is part of the ventilation path. In addition, the locking sleeve 2 preferably includes a preferably annular circumferential recess on the inside, which acts as an axial throttle gap 2.2 between the locking sleeve 2 and the valve housing 18, the axial throttle gap 2.2 also being part of the ventilation path. Preferably at the opposite axial end at which the paragraph in question is located, the end of the locking sleeve 2 preferably acts as a stop for the valve actuator 16; on the one hand in the non-triggered state of the locking sleeve 2 and on the other hand in the triggered state of the locking sleeve with the valve actuator 16 fully screwed in. For this purpose, the valve actuator 16 preferably comprises a further shoulder running around the outside, which interacts accordingly with the locking sleeve 2.

Inside the valve housing 18 there is preferably the servo piston 8, which can cover an axial movement path within the valve housing 18. The servo piston 8 is preferably sealed from the valve housing 18 by means of a sealing element 7. The servo piston 8 runs at least partially axially within a sliding sleeve 4, preferably within a hollow cylindrical section 33 of the sliding sleeve 4. The sealing between the sliding sleeve 4 and the servo piston 8—when the servo piston 8 is in the corresponding position in which the ventilation path is blocked—preferably takes place via a sealing element 24. The sliding sleeve 4 preferably comprises at least one transverse bore 4.1, which is part of the vent path. This at least one transverse bore 4.1 can be blocked by the servo piston 8, preferably by a shoulder of the servo piston 8, whereby the entire ventilation path is blocked. A servo piston spring 14 is preferably located between a shoulder of the servo piston 8 and the shoulder of the sliding sleeve 4. The sliding sleeve 4 also preferably includes the valve receptacle 23 for the service valve 1 and an apron 22, which will be illuminated in more detail later.

The valve spindle 10, which can be moved axially up and down (along the valve axis 15) by the valve actuator 16, preferably runs inside the servo piston 8 and the sliding sleeve 4. The valve spindle 10 preferably comprises a first valve element 10.1, which is preferably plate-shaped. This first valve element 10.1 preferably comprises a sealing element 6, which seals the first valve element 10.1 from the valve housing 18. The servo piston 8 preferably comprises a correspondingly plate-shaped recess in which the first valve element 10.1 can be at least partially accommodated and with which the servo piston 8 can be moved against the spring force of the servo piston spring 14. This plate-shaped recess is preferably also part of the servo space 20, which will be discussed in more detail in the later sections.

The servo piston 8 also preferably comprises a sealing surface 8.3, which preferably interacts with the second valve element 10.2 or a sealing element 7 on the second valve element in such a way that the servo piston 8 can sit on the second valve element 10.2 in a sealing manner on the valve seat. The sealing surface 8.3 of the servo piston 8 is preferably designed obliquely and preferably analogous to the inclination of the second valve element 10.2. At the lower axial end (end in the direction of the service valve 1), the valve spindle 10 also preferably includes a hold-down device 10.5, which preferably merges into the rest of the valve spindle 10 via a collar 31. This collar 31 serves the required self-alignment function of the hold-down device 10.5. This “self-alignment” is preferably achieved through the interaction of the collar 31 with a constriction of the radial cross section of the sliding sleeve 4.

In order to connect the space below this collar 31—which can be the dead space 21 or part of the dead space 21—with the interior of the servo piston 8 and the sliding sleeve—which can be the servo space 20 or part of the servo space 20—in order to ensure there—depending on the valve positions—the flow path with a sufficient cross section to the connection 19 or to carry out the ventilation via the ventilation path, valve spindle 10 in its interior comprises a flow path. For this purpose, the hold-down device 10.5 preferably comprises a first radial bore 10.3.1, which merges into a second radial bore 10.3.2 intersected with it in the valve spindle 10 itself via an axial bore 10.4 intersected with it. Alternatively, the collar 31 can be formed on the cylinder surface with flow paths running parallel to the valve axis 15 in order to ensure the described flow path with a sufficient cross section.

A rolling bearing 34 can be present between the servo piston 8 and the sliding sleeve 4, preferably in the form of a ball sleeve, in order to facilitate the relative movement of both parts to one another.

In addition, for a better overview, individual positions and steps when using the connection fitting 0 are shown below, which describe the coupling of the service valve 1 and the opening and closing of the connection adapter 0.

### Coupling and Locking a Service Valve 1 (See FIG. 3)

FIG. 3 finally shows the connection adapter 0 exactly at the moment after it was connected to the service valve 1. Directly during connection to the service valve 1, the pressure of the dead space 21 is relieved via the ventilation holes arranged in series in the ventilation path in order to prevent the connection adapter 0 from blowing off if a corresponding pressure would cause the connection adapter 0 to do so. These ventilation holes are chronologically the transverse bore 4.1 of the sliding sleeve 4, the transverse bore 18.2 of the valve housing 18 and the transverse bore 2.1 of the locking sleeve 2. Between the transverse bore 18.2 and the transverse bore 2.1 there is preferably an axial throttle gap 2.2 for safe venting even at high pressures.

In the course of inserting the service valve 1, the sliding sleeve 4 with the valve receptacle 23 is pushed along the valve axis 15 and against the force of the servo piston spring 14 into a defined position in the direction of the valve actuator 16.

The sealing of the service valve 1 to the dead space 21 is preferably ensured by the valve seal 26 in that the sealing surface 25 of the sliding sleeve 4 is designed in such a way that the service valve 1 rests against the sealing surface 25 in such a way that the valve seal 26 can rest securely on the circumferential surface of the service valve 1 provided for this purpose.

The valve seal 26 can advantageously be designed as a D-ring in order to eliminate the risk of spiral failure.

As already mentioned, locking balls 3 are inserted into the radial cone bores 12, which are preferably introduced into the valve housing lower part 18.1 of the valve housing 18. By pushing in the service valve 1, the sliding sleeve 4—and here preferably the apron 22 of the sliding sleeve 4—releases the conical bores 12, whereby the locking balls 3 are pressed into the circumferential locking groove 32—preferably in the form of an annular groove—of the service valve 1 by the sliding sleeve 4, which is acted upon by the force of the servo piston spring 14, and blocked in this position.

If the sliding sleeve 4 were to be pushed into the valve housing 18 without the service valve 1 until the conical bores 12 were released, the locking balls 3 would block the insertion of the service valve 1.

Because the locking balls 3 no longer block the locking sleeve 2, the locking sleeve 2 snaps axially downwards (in the direction of the service valve 1) by the spring force of the spring 13 and is also held there by the spring force. This “snapping” occurs axially downwards up to the stop element 9. As a result, the locking balls 3 are pressed further into the locking groove 32 of the service valve 1 and locked there. In general, in this condition shown, the service valve is now firmly locked to the connection adapter 0. By “snapping” the locking sleeve 2, the valve actuator 16 is also released, since it is now no longer prevented from rotating by the locking sleeve 2.

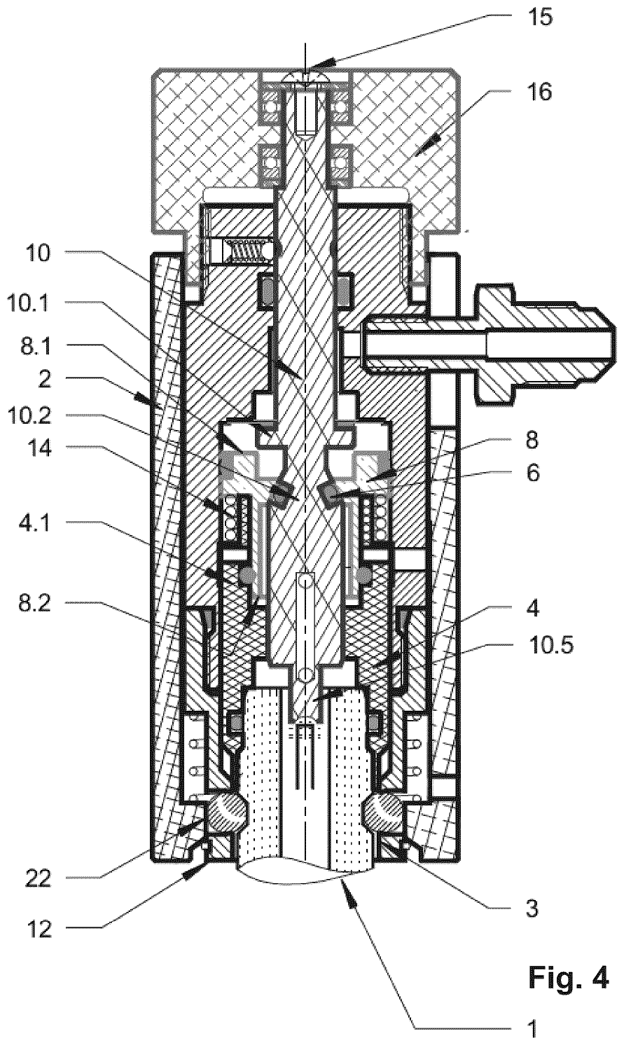

### Start of Opening (See FIG. 4)

By turning the valve actuator 16, preferably clockwise, the valve spindle 10 is moved downwards along the valve axis 15 (towards the service valve). Rolling bearings 11, preferably in the form of ball bearings, prevent the transmission of the rotary movement of the valve actuator 16 to the valve spindle 10 with the first valve element 10.1, the second valve element 10.2, the hold-down device 10.5 and the servo piston 8. Thus the sealing elements of the two valve elements 10.1 and 10.2 and the servo piston 8 can move exclusively in the axial direction without rotational movement.

FIG. 4 shows how the rotation of the valve actuator 16 opens the first valve element 10.1, while the second valve element 10.2 still remains closed.

The force acting in the servo chamber 20 on the pressure-loaded surface 8.1 of the servo piston 8—when the first valve element 10.1 is open and pressure prevails in the servo chamber 20 via the connection 19—reinforces the sealing effect of the sealing element 6 on the sealing surface 8.3, while at the same time the vent hole 4.1 is securely closed by the axial, pressure-controlled movement of the servo piston 8. The dead space 21 is thus hermetically encapsulated. The path of the servo piston 8 is limited by the stop on the sliding sleeve 4, which is locked in its position by the attached service valve 1.

Due to the force acting on the pressure-loaded surface 8.1 of the servo piston 8, the sliding sleeve 4 is pressed onto the locking balls 3 in the conical bores 12. Due to this force, which becomes stronger as the system pressure increases, the locking balls 3 are preferably permanently pressed against the apron 22 of the locking sleeve 2, with the apron 22 acting as a ball bearing, and the locking sleeve 2 is thereby locked in this position.

The ratio of the pressure-loaded surfaces 8.1 and 8.2 of the servo piston 8 and the force of the servo piston spring 14 are advantageously chosen so that the servo piston 8 is pressed against the force of the servo piston spring 14 onto the sealing surface 8.3 of the second valve element 10.2 and/or onto the stop of the sliding sleeve 4 at a system pressure which is larger than the limit pressure (preferably >=1 MPa).

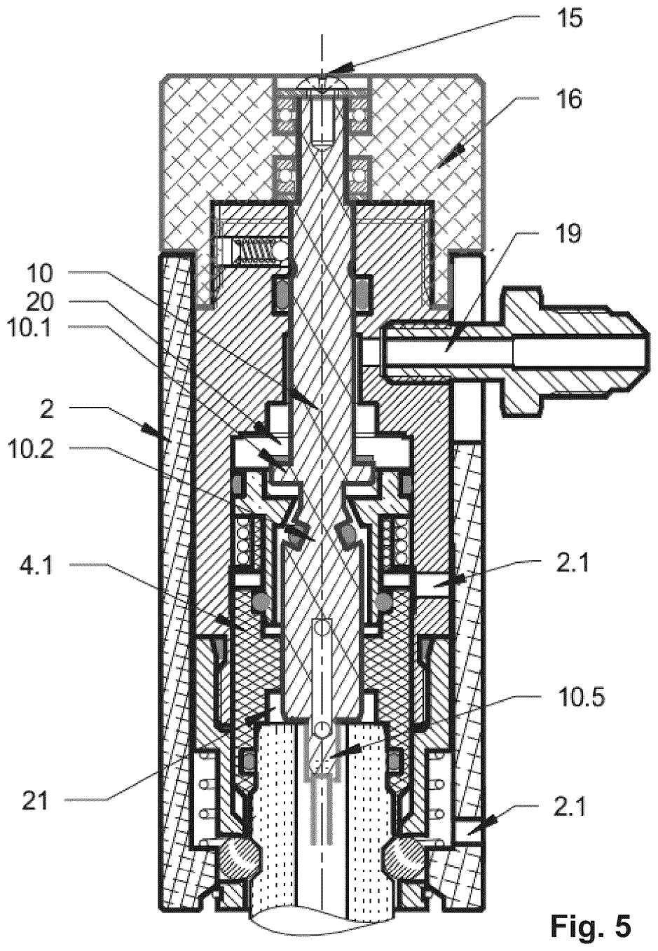

### Full Opening (See FIG. 5)

The valve spindle 10 is moved clockwise along the valve axis 15 in the direction of the service valve 1 by further turning the valve actuator 16 as far as it will go, as a result of which the second valve element 10.2 is also opened and the flow path between the servo space 20 and the dead space 21 is created.

At the same time, the spring valve insert 29 of the service valve 1 is pressed by the hold-down device 10.5, thereby creating a flow path between the dead space 21 and the external system which includes the service valve 1. The flow path between connection 19 via the first valve element 10.1, second valve element 10.2 and service valve 1 is thus created for the evacuation and/or filling of an external system.

Due to the advantageous design of the length of the locking sleeve 2 and the possible movement space of the locking sleeve 2 in the axial direction along the valve axis 15, decoupling from the service valve 1 can only take place if the valve actuator 16 has been completely brought into the end position—preferably by turning it counterclockwise—and both valve elements 10.1 and 10.2 of the valve spindle 10 are completely closed.

This creates double security against decoupling from a service valve 1, since in this (upper) position of the valve actuator 16, the ventilation path via the ventilation holes is necessarily open.

In general, the formation of a ball counter bearing through the apron 22 on the locking sleeve 2 is preferred. When the valve elements 10.1 and 10.2 are open and the servo piston 8 is subjected to pressure, the positive connection via the sliding sleeve 4, the locking balls 3 and the ball abutment prevents the locking sleeve 2 from being displaced along the valve axis 15 in the direction of the valve actuator 16, so that the lock remains fixed. If given, the locking sleeve 2 can also be designed in such a way that the mechanical stop on the opened valve actuator 16 can be omitted. The attached service valve 1 is therefore securely coupled to the connection adapter 0.

A service valve 1 that does not close correctly on a circuit that is at least partially supplied with coolant is detected by the coolant flowing out via the dead space 21 and the vent path.

If the connection fitting is also to be used for evacuation, the first valve element 10.1 must be designed in such a way that when the connection adapter 0 is opened, the first valve element 10.1 forces the servo piston 8 downwards against the spring force of the servo piston spring 14 in order to close the ventilation hole 4.1 before the evacuation process is initiated.

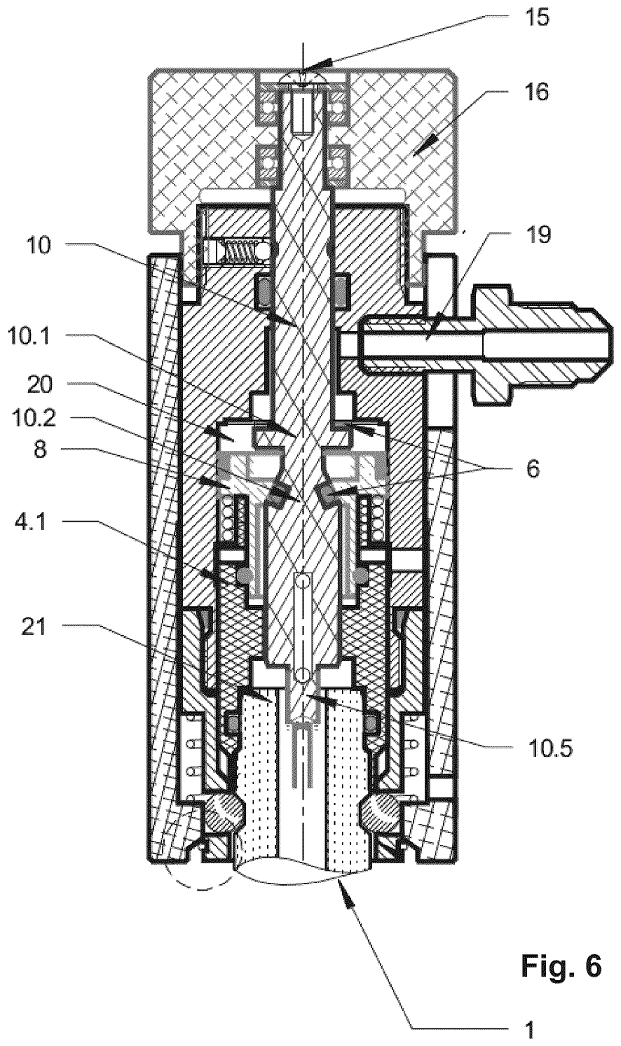

### Start of Closing (See FIG. 6)

From the fully open state shown in FIG. 5, the closing of the connection adapter 0 can now be initiated.

By turning the valve actuator 16 counterclockwise, the valve spindle 10 is displaced along the valve axis 15 in the direction of the valve actuator 16. First, the second valve element 10.2 closes.

The pressure-loaded servo piston 8 generates the necessary counterforce on the sealing surface 8.3. The hold-down device 10.5 lifts off from the spring valve insert 29 of the service valve 1.

The flow path between dead space 21 and the connected (cooling) circuit and between servo space 20 and dead space 21 is interrupted. The vent path is still closed.

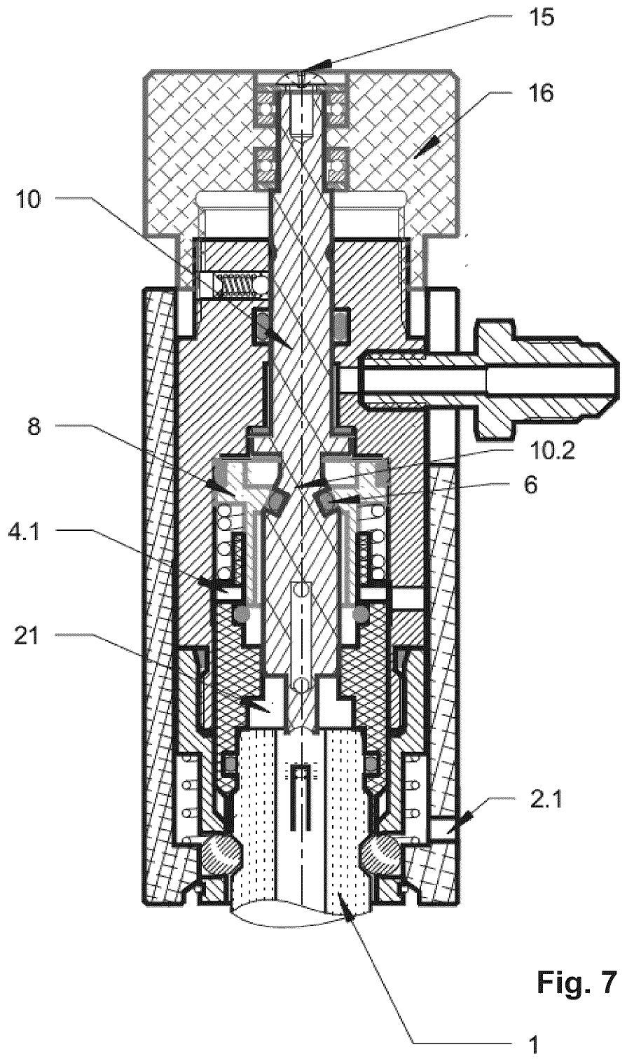

### Complete Closure (See FIG. 7)

By further turning the valve actuator 16 counterclockwise until the stop, the valve spindle 10 is moved further along the valve axis 15 in the direction of the valve actuator 16. The second valve element 10.2 remains closed and the first valve element 10.1 also closes. The servo piston 8 is also moved upwards by the second valve element 10.2 and the transverse bore 4.1 is released. The flow path between servo space 20 and dead space 21 is interrupted. The pressure in the dead space 21 is reduced by the opened ventilation path and a leaky spring valve insert 29 in the service valve 1 could be detected by the fact that the pressure-loaded medium constantly flows out of the ventilation path into the environment.

Furthermore, conclusions can be drawn about spring valve inserts 29 in the service valve 1 that do not close correctly or about a defective sealing element 6.

### Decoupling the Service Valve (if No Medium Flows Out)

Only when the valve actuator 16 has been fully rotated counterclockwise to the stop can the locking sleeve 2 be manually moved in the direction of the valve actuator 16 against the force of the tension spring 13. The locking balls 3 are pressed out of the locking groove 32 of the service valve 1 by the force of the servo piston spring 14 via the frictional connection with the sliding sleeve 4. The sliding sleeve 4 presses the service valve 1 out of the connection adapter 0 so that it can be removed and the initial state is reached again.

Some variants of maintenance stations reduce the pressure after completion of a filling process via the maintenance station and not via the connection adapter. For this reason, it is preferred if the connection adapter 0 can also be adapted to this design.

The closing of the connection adapter 0 is divided into two phases. The transition from the beginning closing phase to the final phase is preferably signaled by a noticeably recognizable, preferably haptic, feedback on the valve actuator 16.

The beginning phase serves to interrupt the flow path between service valve 1 and dead space 21.

By turning the valve actuator 16 counterclockwise, the hold-down device 10.5 is lifted from the pin of the spring valve insert 29 in the coupled service valve 1, whereby the flow path to the circuit connected to the service valve 1 is interrupted. The required stroke is defined by standard according to the respective coolant.

An example of this process is the coolant R744 after a stroke of the valve spindle 10 with the hold-down device 10.5 of 2.5 mm securely completed. When this point is reached, the feedback described preferably occurs through a noticeable increase in resistance when turning the valve actuator 16 counterclockwise. For this purpose, a circumferential groove, preferably in the form of an annular groove 27, is preferably present on the valve spindle 10 at the defined point. The increase in resistance is caused by a locking ball pin 28, which is inserted transversely to the valve spindle 10 into the valve housing 18 and presses against the shaft of the valve spindle 10.

If a connection adapter 0 is connected to a maintenance station in which the pressure is to be reduced via this maintenance station, the operator interrupts the rotary movement of the valve actuator 16 and starts the ventilation on the connected fluid system.

The flow path between servo chamber 20 and connection 19 is open so that the excess pressure can escape from servo chamber 20. When the force on the first pressure-loaded surface 8.1 of the servo piston 8 decreases, it is moved to the upper stop by a force acting on the second pressure-loaded surface 8.2 and the force of the servo piston spring 14.

This opens the second valve element 10.2. At the same time, the ventilation hole 4.1 is released through the servo piston 8. The excess pressure in the dead space 21 is reduced via the valve elements 10.1 and 10.2 to the connection 19 and via the series-connected transverse bores 4.1, 2.1 and 18.2 of the ventilation path.

### Further Embodiment

This (further) embodiment corresponds to the previously described embodiment or embodiments and only differs in that the connection adapter 0 does not have a first valve element 10.1. The valve element 10.1 is not necessary in this embodiment. The other features or the advantageous and preferred features that are described in connection with the previously described embodiment or the previously described embodiments also apply to this (further) embodiment and are correspondingly advantageous or preferred, and are also claimed for this further embodiment.

In particular, independent protection is thus also provided for a connection adapter 0 for docking and undocking a maintenance station to a service valve 1 of a third-party system in which a working fluid circulates in a closed circuit, in particular an air conditioning system with a connection 19, via which working fluid under pressure can be fed from the maintenance station into the connection adapter 0 for filling or via which working fluid under pressure can be discharged can be provided with a dead space 21 which is ventilated via a venting path even when the service valve 1 is coupled to the connection adapter 0, with a servo space 20 which can be connected fluidically to the connection 19 and in which a servo piston 8 is accommodated for opening and closing the venting path, which an excess pressure present in the servo space 20 pushes towards its position closing the venting path, and with a valve spindle 10, which actuates a valve element 10.2 (the valve element 10.2 is described as a second valve element in the embodiment described above), the valve spindle 10 not actuating a valve element 10.1 (the valve element 10.1 is described as a first valve element in the embodiment described above), which is designed and positioned so that when the valve spindle 10 moves to the opening the service valve 1 connects fluidically the servo space 20 with the connection 19, and the valve element 10.2 (here, the second valve element 10.2) is designed and positioned so that it only opens and connects the dead space 21 fluidically with the servo space 20 after the servo piston 8 has reached a position closing the ventilation path, and with a hold-down device 10.5 for opening one component of the spring valve insert 29 forming the service valve 1, which is designed and arranged in such a way that it only opens the spring valve insert 29 after the servo piston 8 has reached a position closing the ventilation path.

A connection adapter 0 is advantageously used for docking and undocking a maintenance station to a service valve 1 of a third-party facility without a valve element 10.1, the valve element 10.1 being described as the first valve element in the embodiment described above. This embodiment can therefore be described like the embodiment described above, only without the first valve element 10.1.

The valve spindle 10 of the connection adapter 0 advantageously actuates only a single valve element 10.2 (the valve element 10.2 being described as a second valve element in the embodiment described above), the valve element 10.2 being designed and positioned so that it only opens and connects the dead space 21 fluidically with the servo space 20 after the servo piston 8 has reached a position closing the ventilation path.

Advantageously, the servo space 20 fluidically is connected to the connection 19 before the valve element 10.2 opens and connects the dead space 21 fluidically to the servo space 20 after the servo piston 8 has reached a position closing the ventilation path.

1. A connection adapter for docking and undocking a maintenance station to a service valve of a third-party system in which a working fluid circulates in a closed circuit with a connection via which for filling the working fluid under pressure can be fed from the maintenance station into the connection adapter or through which the working fluid under pressure can be discharged, with a dead space which is ventilated via a ventilation path even when the service valve is coupled to the connection adapter, the connection adapter comprising:
a servo space on fluidically connectable to the connection, wherein the servo space accommodates a servo piston for opening and closing the ventilation path, wherein an excess pressure in the servo space pushes the servo piston towards its a position closing the ventilation path,
a valve spindle which operates a first valve element and a second valve element,
wherein the first valve element is designed and positioned in such a way that when the valve spindle moves to open the service valve, the first valve element connects the servo space fluidically with the connection,
and the second valve element is designed and positioned so that the second valve element only opens and connects the dead space (fluidically with the servo space after the servo piston has reached a position closing the ventilation path, and
with a hold-down device for opening a spring valve insert which forms part of the service valve, wherein the hold-down device is designed and arranged in such a way that the hold-down device only opens the spring valve insert after the servo piston has reached a position closing the ventilation path.

2. A connection adapter for docking and undocking a maintenance station to a service valve of a third-party system in which a working fluid circulates in a closed circuit with a connection via which for filling the working fluid under pressure can be fed from the maintenance station into the connection adapter or through which the working fluid under pressure can be discharged, with a dead space which is ventilated via a ventilation path even when the service valve is coupled to the connection adapter, the connection adapter comprising:
a servo space fluidically connectable to the connection, wherein the servo space accommodates a servo piston for opening and closing the ventilation path, wherein an excess pressure in the servo space pushes the servo piston towards its a position closing the ventilation path,
a valve spindle which operates a valve element, wherein the valve element is designed and positioned so that the valve element only opens and connects the dead space fluidically with the servo space after the servo piston has reached a position closing the ventilation path, and
a hold-down device for opening the spring valve insert which forms part of the service valve, wherein the hold-down device is designed and arranged in such a way that the hold-down device only opens the spring valve insert after the servo piston has reached a position closing the ventilation path.

3. The connection adapter for docking and undocking a maintenance station to a service valve of a third-party system in which a working fluid circulates in a closed circuit according to claim 1, wherein the servo piston has at least one upper pressure-loaded end face and at least one lower pressure-loaded end face, a ratio of which is selected so that whenever there is a pressure in the servo space which is larger than a limit pressure, the servo piston is pressed sealingly against the second valve element against a force of a servo piston spring and/or against a stop of a sliding sleeve and/or when there is a pressure in the servo space which is smaller than a limit pressure, by the force of the servo piston spring pressed at an upper stop at a valve housing.

4. The connection adapter for docking and undocking a maintenance station to a service valve of a third-party system in which a working fluid circulates in a closed circuit according to claim 1, wherein the valve spindle used to control the valves that connect the connection with the dead space includes the first valve element and the second valve element, and the valve spindle cooperates with a valve seat on the servo piston in such a way that the servo piston can be held by the second valve element when coupling the connection adapter against a pressure in the servo space in a position that does not close the ventilation path and when uncoupling the connection adapter can be pulled from its position that closes the ventilation path into a position that does not close the ventilation path.

5. The connection adapter for docking and undocking a maintenance station to a service valve of a third-party system in which a working fluid circulates in a closed circuit according to claim 1, characterized in that wherein the valve spindle forms the hold-down device at one end for opening the spring valve insert forming part of the service valve, which merges into a remainder of the valve spindle via a collar for self-alignment of the hold-down device, the hold-down having a first radial bore which extends via an axial bore intersected with the first radial bore into a second radial bore intersected with the axial bore in the valve spindle and thus, when the service valve is coupled, preferably creates a fluid connection between a space below a collar of the valve spindle and a space within the servo piston and within a sliding sleeve.

6. The connection adapter for docking and undocking a maintenance station to a service valve of a third-party system according to claim 1, wherein the first valve element is designed and positioned in such a way that, if there is no excess pressure in the servo chamber, the first valve element can press the servo piston by positive locking into a position that closes the ventilation path.

7. The connection adapter for docking and undocking a maintenance station to a service valve of a third-party system according to claim 1, wherein the valve spindle is guided in an axially displaceable manner in a multi-part valve housing, which also delimits the servo space and the dead space and also carries the connection, the valve housing carries a valve actuator connected to the valve housing via a thread, with the help of which the valve spindle can be moved back and forth in an axial direction relative to the valve housing.

8. The connection adapter for docking and undocking a maintenance station to a service valve of a third-party facility according to claim 7, wherein the valve housing carries an axially displaceable locking sleeve relative to the valve housing, which interacts positively with the valve actuator and interacts positively with locking balls for locking a service valve in its connected position, in such a way that, as long as no service valve is connected to the connection adapter, the locking sleeve is supported against the locking balls in such a way that the locking sleeve cannot be displaced further beyond the locking balls in the axial direction and thereby forms a stop for the valve actuator, which prevents its the valve actuator from further axially shifting in the direction of the valve housing and/or in such a way that the valve actuator, as long as a service valve is connected and the first valve element is not yet closed, prevents the locking sleeve from being moved into its unlocking position, in which the locking sleeve allows the locking balls to be displaced in a radially outward direction.

9. The connection adapter for docking and undocking a maintenance station to a service valve of a third-party system according to claim 8, wherein a sliding sleeve is supported on the servo piston via a spring element, which has an apron on an outside end, which forms a ball counter bearing which, as long as there is no service valve coupled to the connection adapter, the locking balls blocked between the sliding sleeve and the locking sleeve in such a way that they the locking balls hold the locking sleeve captive between the locking balls and the valve actuator, and by pushing in the service valve the service valve is moved so far in a direction of the servo piston that the apron releases the locking balls to be inserted into a corresponding locking groove of the service valve.

10. The connection adapter for docking and undocking a maintenance station to a service valve of a third-party system according to claim 9, wherein the locking sleeve is pretensioned relative to the valve housing, by a spring, wherein the locking sleeve using said spring presses the locking balls in a radially inward direction into the locking groove of the service valve and holds the locking balls there captive and as soon as the sliding sleeve has been moved so far in the direction of the servo piston the apron releases the locking balls.

11. The connection adapter for docking and undocking a maintenance station to a service valve of a third-party system according to claim 9, wherein the sliding sleeve has a hollow cylindrical section into which the servo piston is sealingly immersed in order to close the ventilation path.

12. The connection adapter for docking and undocking a maintenance station to a service valve of a third-party system according to claim 9, wherein the servo piston and the sliding sleeve are mounted together via a rolling bearing.

13. The connection adapter for docking and undocking a maintenance station to a service valve of a third-party system according to claim 9, wherein the sliding sleeve forms a stop for the servo piston, which prevents a further axial displacement of the servo piston in a direction of the service valve.

14. The connection adapter for docking and undocking a maintenance station to a service valve of a third-party system according to claim 9, wherein the sliding sleeve transmits a pressure force communicated to the sliding sleeve by the servo piston to the locking balls.

15. The connection adapter for docking and undocking a maintenance station to a service valve of a third-party system according to claim 1, wherein the valve spindle passes over a locking point which haptically informs a user when a valve actuator is actuated that from now on the user is pushing open the spring valve insert and/or a forced opening of the spring valve insert ends, the locking point being generated by a locking ball pin, a ball of which is temporarily inserted into an annular groove of the valve spindle.

16. The connection adapter for docking and undocking a maintenance station to a service valve of a third-party system according to claim 9, wherein the ventilation path through at least one transverse bore in the sliding sleeve, at least one transverse bore in the valve housing and a further part of the ventilation path through at least one transverse bore in the locking sleeve is formed, the transverse bore being offset from a remainder of the ventilation path in such a way that an axial throttle gap is formed between the remainder of the ventilation path and the transverse bore.

17. The connection adapter for docking and undocking a maintenance station to a service valve of a third-party system according to claim 1, wherein the closed circuit is an air conditioning system.

18. The connection adapter for docking and undocking a maintenance station to a service valve of a third-party system according to claim 2, wherein the closed circuit is an air conditioning system.

19. The connection adapter for docking and undocking a maintenance station to a service valve of a third-party system according to claim 1, wherein the first valve element is a cylindrical ring-shaped valve plate and the second valve element is a conical section-shaped valve plate.

20. The connection adapter for docking and undocking a maintenance station to a service valve of a third-party system according to claim 1, wherein the valve spindle is connected to the valve actuator via roller bearings.
